(19) United States
(12) Patent Application Publication
(10) Pub. No.: US 2014/0065036 A1
(43) Pub. Date: Mar. 6, 2014

(54) Tray Support for Chromatographic Equipment

(71) Applicant: Matthew Orcutt, Fort Wayne, IN (US)

(72) Inventor: Matthew Orcutt, Fort Wayne, IN (US)

(21) Appl. No.: 14/018,598

(22) Filed: Sep. 5, 2013

Related U.S. Application Data
(60) Provisional application No. 61/697,205, filed on Sep. 5, 2012.

(51) Int. Cl. B01L 3/00

(52) U.S. Cl. CPC B01L 3/5085
USPC 422/552

(57) ABSTRACT

A universal tray holder assembly on a CTC prep and load instrument is disclosed. The assembly contains sample tray and a tray support block attached directly to the sample tray, support legs attached to the tray support block at a first edge of the support legs, and clamps attached to the support leg at a second edge that is distal to the first edge. The sample tray is reversibly detachable from the tray support block when the clamps are attached to the x-beam rail, and removal and subsequent replacement of the sample tray onto the support block results in no change in the x and y positions of any sites on the sample tray relative to the positions before tray removal. The invention saves time during installation and removal because the operator does not need access to the back of the chromatograph instrument. Positions do not need to be re-taught if access to underneath the sample tray is needed. Trays can be changed without the need for purchasing a different tray holder.

### PRIORITY INFORMATION

This application claims priority under 35 USC 119 to provisional patent application number 61/697,205 filed on Sep. 5, 2012.

### BACKGROUND

In many laboratory settings, it is often desirable to analyze a relatively large number of chemical or biochemical samples in an approximately continuous operation, such as with limited preparation time between samples. In order to stream-line such processes, the manipulation of samples has been mechanized. Such mechanized sampling is commonly referred to as “autosampling”and is performed using an automated sampling device or autosampler. Samples may be accessible to the autosampler by a sampling probe. Typically, samples are positioned on a moveable tray, which positions the samples for access by the sample probe, however, samples may also be positioned on a stationary tray for access by a moveable sample probe.

A “prep and load” (PAL—Registered trademark of CTC Analytics AG, Switzerland. Also referred to herein as “CTC-PAL”) machine is a device and process for delivering samples from a multi-sample tray to chromatographic equipment. The device is essentially an x, y, z, robot that removes samples via a syringe from sample vials located in a tray to the inlet port of analytical equipment. Conventional means for attaching sample trays to a prep and load device involve placing a sample tray onto a rigid platform which is reversibly attached to a beam on the platform. This method of attachment has the disadvantage that any adjustments that need to be made to the equipment involve complete removal of the platform, which means also needing to access the rear of the equipment. Depending on the location of the equipment, rear access may not be convenient and may result in down time for the equipment.

What is needed is a device and process for attaching a sample tray to a prep and load device that allows for fast removal of the tray and precise reattachment when necessary.

### SUMMARY OF THE INVENTION

In one embodiment the present invention is directed to a tray assembly for attaching to a chromatograph autosampler. The tray assembly comprises;

a sample tray comprising a multiplicity of sites for holding sample vials,

a tray support block attached directly to the sample tray, support legs attached to the tray support block, each support leg being attached to the support block at a first edge, and

clamps attached to the support legs, each support leg being attached to a clamp at a second edge of the support leg that is distal to the first edge.

X and y directions define a horizontal plane and a z direction is defined as the vertical direction perpendicular to the horizontal plane. The first and second edges of the support legs are located in fixed positions relative to each other in the z direction when the clamp is attached to the X-beam rail of an autosampler.

The clamps are configured to be able to attach the assembly to an x-beam rail of a prep and load device on an autosampler. The sample tray is reversibly detachable from the tray support block when the clamps are attached to the X-beam rail. The sample tray can be removed and replaced from the tray support block with the clamp attached to an X beam rail of an autosampler, and removal and subsequent replacement of the sample tray onto the support block results in no change in the x and y positions of any of the multiplicity of sites relative to the positions of the sites before tray removal.

In a further embodiment, the sample tray comprises two or more guide rods projecting from an edge of the tray.

In a still further embodiment, the tray support block comprises a first set of guide rod receiving holes in an edge of the tray support block, said guide rod support holes being dimensioned to receive the guide rods in a sufficiently tight fit to hold the sample tray in place such that the multiplicity of sites are held in fixed x and y positions, but allowing a user to manually remove the sample tray from the support block, said guide rod support holes extending into said block. The guide rods are inserted into the guide rod receiving holes such that the sample tray sits with the first edge against the edge of the support block that contains the holes.

Each guide rod may further comprise a groove positioned around its circumference and the tray support block comprises a hole and a thumbscrew located in the hole such that the thumbscrew engages the groove when the tray is positioned with the guide rods in the first set of holes.

In a still further embodiment, the tray support block comprises two or more guide rods projecting from an edge of the tray and the sample tray comprises a first set of holes dimensioned to receive the guide rods, said holes extending into one edge of the sample tray.

The support legs may further be in the form of plates and the first and second edges have holes through which the clamp and tray support blocks respectively are secured with screws.

### BRIEF DESCRIPTION OF THE FIGURES

FIG. 1 shows a drawing in perspective of a conventional tray support.

FIG. 2 shows a plan view of a tray that is employed in an embodiment of the invention.

FIG. 3 shows a side view of a guide rod employed in an embodiment of the invention.

FIG. 4 shows a plan view of an assembly of a tray, guide rod, tray support block, and clamp that is an embodiment of the present invention.

FIG. 5 shows a side view of the assembly of FIG. 4.

FIG. 6 shows views of an example of a tray support block of the invention.

FIG. 7 shows a view of an example of a support leg employed in the invention.

FIG. 8 shows an example of a clamp of the invention.

### DETAILED DESCRIPTION OF THE INVENTION

### Definitions

The “X-direction beam” or “X-beam” is the structure on a prep and load machine that comprises the movable member to which a tray support is connected. The “X-beam rail” refers to the structure within the X-beam to which the present invention is clamped and that allows the sample tray to be moved in the x-y direction.

“Sample tray” refers to a tray, generally comprising a multiplicity of sites into which sample vials may be paced. Typically the sites will be wells or holes, into which sample vials are placed. The tray is oriented with the surface that contains the wells or holes horizontal relative to a laboratory bench or other surface onto which the machine is placed such that the sample vials are held in a stable position during sampling.

The tray support block is a structure that holds the sample tray securely in the required orientation in the present invention, and also attaches the sample tray to the X-direction beam via support legs and clamps as described below.

The sample tray may be attached to the tray support block via guide rods that are attached to an edge of the tray support block. The guide rods may be cemented or screwed into the tray via holes drilled into the edge of the tray. The guide rods may be held in place in the tray support block by being inserted into holes in the tray support block. The guide rods may further be held in place in the tray support block by screws that are inserted into threaded holes in the tray support block, said screws engaging the guide rods. The guide rods may have grooves or indentations located in their circumference that engage the screws. Guide rods may be cemented into support block or tray, and then be removable inserted into the tray or block respectively.

By ‘support leg” is meant herein a structure that attaches to the tray support block in order to support the block in a given position relative to the X-direction beam. The support leg may have any cross sectional shape. In a preferred embodiment the support leg is a flat, sheet like structure with a sufficient thickness to contain holes through which screws join the support leg to the tray support block. Generally the tray and support block will be held in a position below the X-direction beam and the support leg will have a shape that is elongated in one direction, with an upper and lower edge. A first edge is connected and secured to the tray support block and a second edge is connected to a clamp that attaches to the X-direction beam. Connections are preferably made by screws through holes in the support leg edges The support leg cross section may be circular, square, rectangular or triangular, or any other shape.

### EMBODIMENTS OF THE INVENTION

As stated above, removing peripherals on a CTC PAL with a conventional tray support requires access to the back of the instrument and requires the operator to reteach positions when they are replaced.

The present invention allows an operator to remove and install the sample tray from the front of the instrument. In addition, just the sample tray can be removed in order to allow quick access to objects underneath it such as when performing maintenance on a detector. The invention saves time when installing and removing the tray because the operator does not need access to the rear of the instrument. The operator further does not have to reteach vial positions if access is needed to underneath the tray holder. A range of tray designs can furthermore be used with the tray support without the need for purchasing a different tray holder.

In one embodiment the present invention is directed to a tray assembly for attaching to a chromatograph autosampler. The tray assembly comprises;

a sample tray comprising a multiplicity of sites for holding sample vials,

a tray support block attached directly to the sample tray,

support legs attached to the tray support block, each support leg being attached to the support block at a first edge, and

clamps attached to the support legs, each support leg being attached to a clamp at a second edge of the support leg that is distal to the first edge.

X and y directions define a horizontal plane and a z direction is defined as the vertical direction perpendicular to the horizontal plane. The first and second edges of the support legs are located in fixed positions relative to each other in the z direction when the clamp is attached to the X-beam rail of an autosampler.

The clamps are configured to be able to attach the assembly to an X-beam rail of a prep and load device on an autosampler. The sample tray is reversibly detachable from the tray support block when the clamps are attached to the X-beam rail. The sample tray can be removed and replaced from the tray support block with the clamp attached to an X beam rail of an autosampler, and removal and subsequent replacement of the sample tray onto the support block results in no change in the x and y positions of any of the multiplicity of sites relative to the positions of the sites before tray removal.

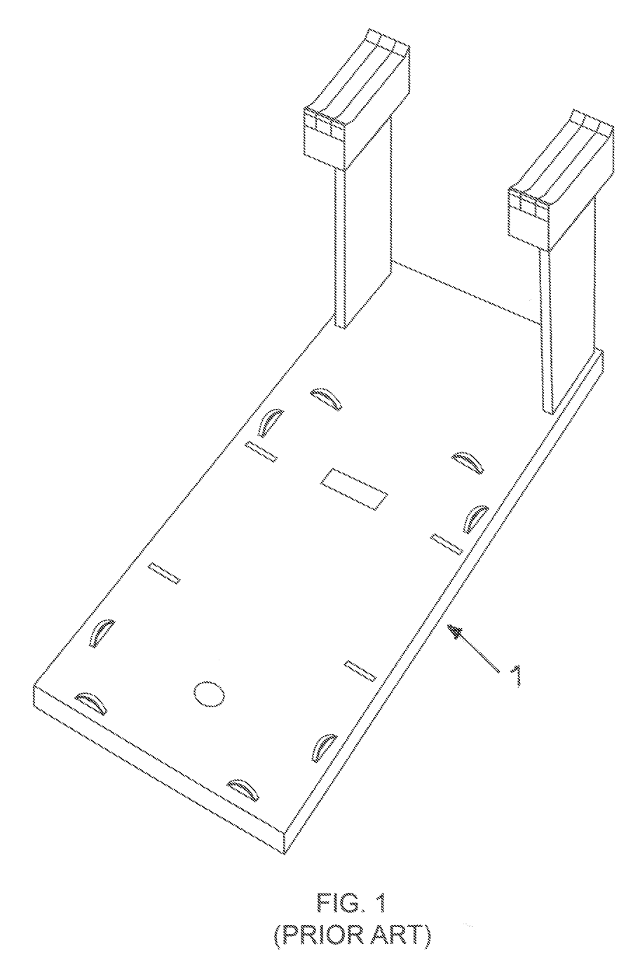

Turning now to the figures, FIG. 1 shows an example of a conventional single piece tray support (1) that is not an embodiment of the present invention. The conventional tray support must be removed in its entirety from the autosampler in order for the autosampler to be accessed.

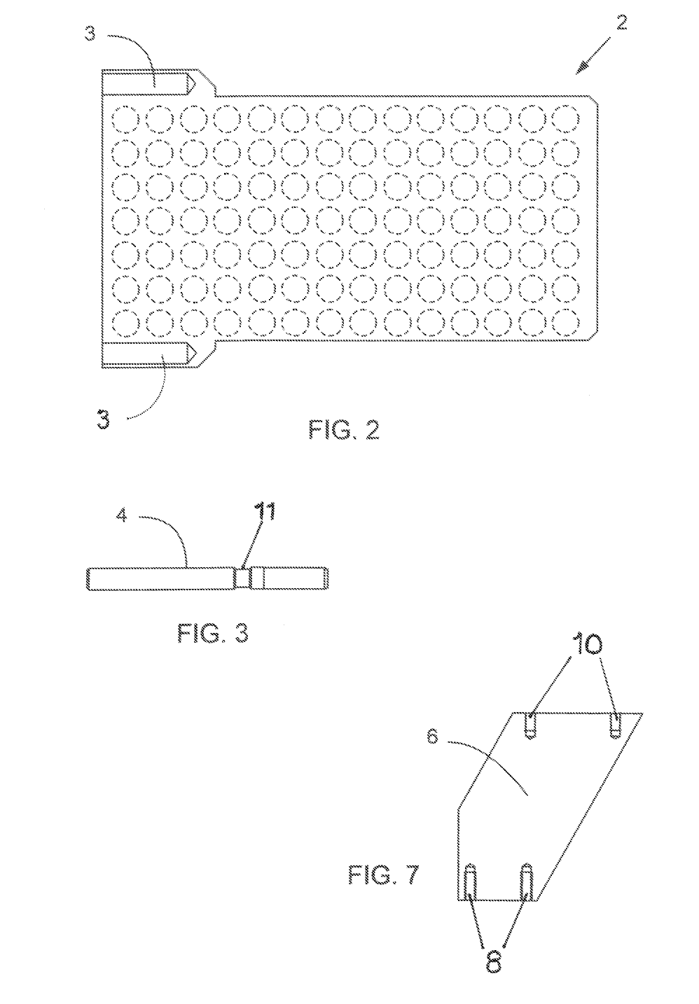

FIG. 2 shows a plan view of an example of an embodiment of the sample tray of the invention. A sample tray (2) comprises one or more holes (3) in one edge. The holes are sized to accept guide rods. The sizing is such that the guide rods can be fixed immovably into the tray. For example, the guide rods can be cemented into the edge of the sample tray. FIG. 3 shows an example of a guide rod (4) that would fit into the hole (3) in the edge of the tray support block (2). The guide rods may also comprise one or more circumferential grooves (11) that engage screws embedded in a tray support block. The screws can be loosened and allow the guide rods to be removed from the tray support block while still being fixed into the tray.

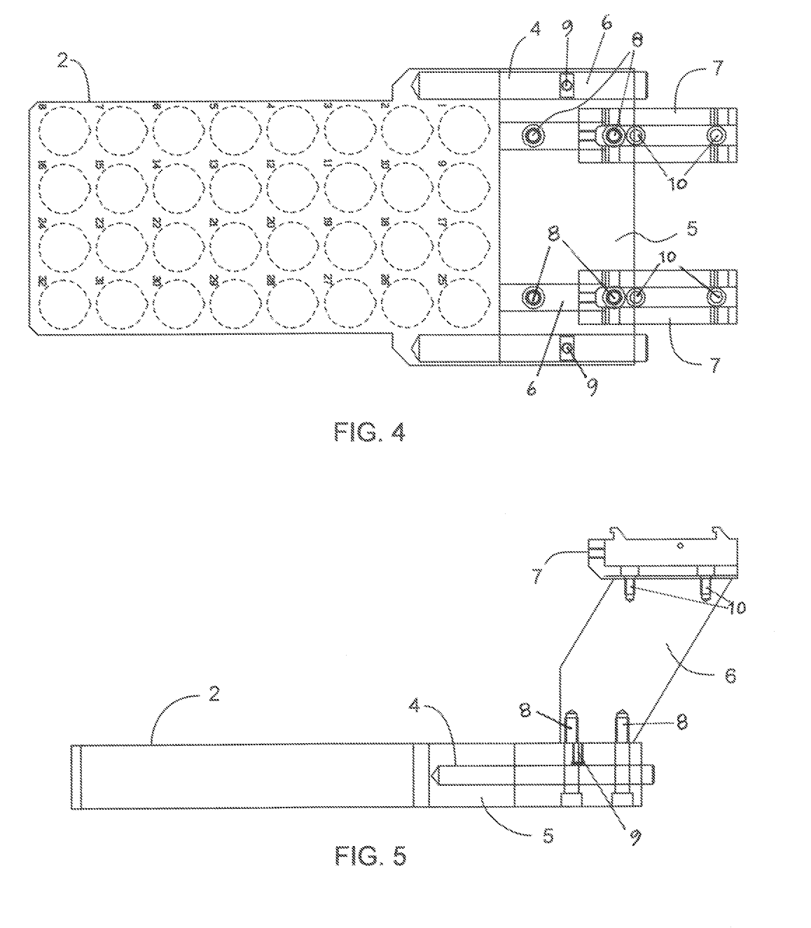

FIGS. 4 and 5 show a plan and side view respectively of the complete assembly of the invention. Sample tray (2) is secured to a tray support block (5) by one or more guide rods (4). As noted above, the guide rods can be immovably fixed to the sample tray. The guide rods fit into holes in the edge of the support block such that the tray is held in place by the support block in an autosampler assembly. The tray plus guide rod is also reversibly removable manually from the support block by an operator if access to the autosampler is required. Threaded holes for screws (9) can be inserted into the tray support block. The screws inserted therein can engage with the guide rod grooves (11) (FIG. 3) to secure the guide rods into the support blocks.

One or more support legs (6) are secured to the tray support block by one of their edges. The edges comprise holes (8) through which screws can be inserted to attach the support legs to the support block. A second edge of the support leg is secured to a clamp (7) that in turn is positioned on the X-beam rail (not shown) of a prep and load device. Screw holes (10) in the edge of the support legs (6) contain screws that fix the support legs to the clamp (7). The sample tray (2) is supported horizontally by the tray support block (5). The support block contains a threaded hole (9) that contains a screw to secure the support block to the guide rod (4).

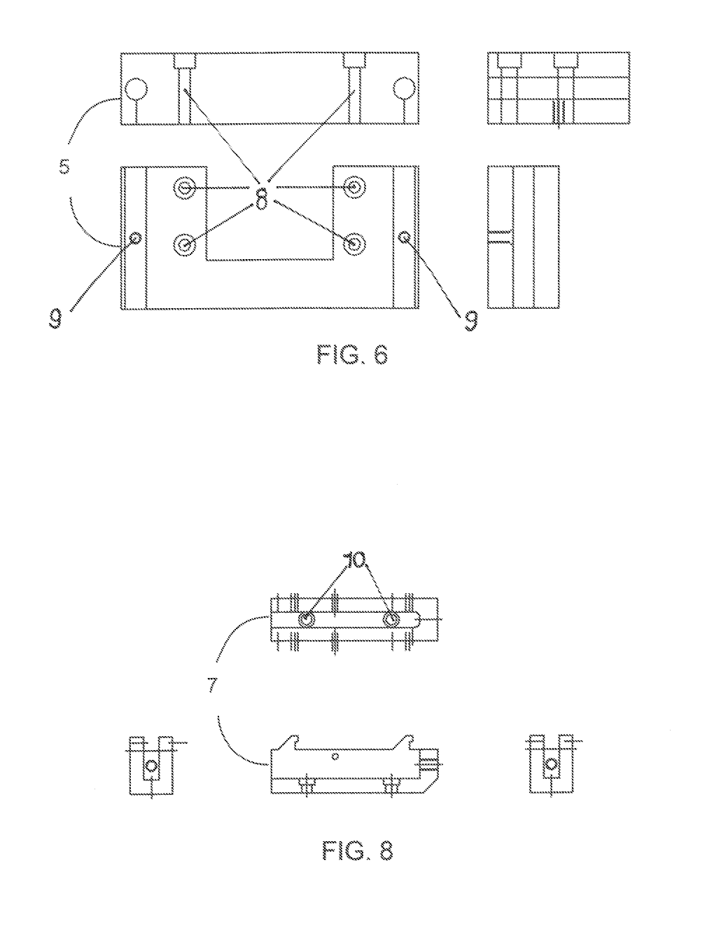

FIG. 6 shows views of an example of a tray support block (5) with screw holes (8) and (9).

FIG. 7 shows a side view of an example of a support leg (6) with screw holes (8) and (10).

FIG. 8 shows views of a typical clamp (7) of the type used to engage with an X-beam. Holes (10) in the base of the clamps allow for the clamps to be secured to the support legs by screws.

The clamp design allows the user to attach the clamps to the x-beam preferably via hooks, making for a quick initial installation or a quick removal. These clamps are secured to the support legs that hold the tray support block preferably by screws that insert into the holes in the base of the clamps. The clamps are secured to the X-beam rail by set screws located in the front of the clamps. The tray support block acts as fixed position and a receptacle for the guide rods. This receptacle type design allows access to whatever might be under the tray without the need for re-teaching positions. The design also makes it possible for other tray types to be accepted into the receiving block.

In one embodiment; the component parts of the invention can be manufactured by first machining the parts from aluminum, followed by cleaning, and anodization. The component parts can be assembled with screws so that the clamps attach to the legs and to the receiving block. The guide rods can be placed in a metal lathe and are notched and angled to fit in the receiving block in such a way that the sample tray is held in place but is still manually removable by an operator. The guide rods can be permanently glued or cemented to each tray.

In operation the tray holder assembly is first secured to the X-beam rail of the CTC PAL by seating the clamp and tightening the front set screws of each clamp. With the tray in the receiving block, the user then teaches the reference position and stores it in the firmware of the CTC PAL. The user can then remove the tray from the receiving block at any time and replace it without re-teaching any positions. This allows for the user to work under the tray. Or the user can also switch between different tray types without purchasing a different tray holder.

I claim:

1. A tray assembly for attaching to a chromatograph autosampler comprising;
a sample tray comprising a multiplicity of sites for holding sample vials,
a tray support block attached directly and reversibly to the sample tray,
support legs attached to the tray support block, each support leg being attached to the support block at a first edge,
clamps attached to the support legs, each support leg being attached to a clamp at a second edge of the support leg that is distal to the first edge
wherein;
x and y directions define a horizontal plane and a z direction is defined as the vertical direction perpendicular to the horizontal plane,
the clamps are configured to be able to attach the assembly to an X-beam rail of a prep and load device on an autosampler,
the first and second edges of the support legs are located in fixed positions relative to each other in the z direction when the clamp is attached to the X-beam rail of an autosampler,
the sample tray is reversibly detachable from the tray support block when the clamps are attached to the X-beam rail, and wherein
the sample tray can be removed and replaced from the tray support block with the clamp attached to an X beam rail of an autosampler, and removal and subsequent replacement of the sample tray onto the support block with the clamps attached to the X-beam rail results in no change in the x and y positions of any of the multiplicity of sites relative to the positions of the sites before tray removal.

2. The tray assembly of claim 1 wherein;
the sample tray comprises two or more guide rods projecting from a first edge of the tray,
the tray support block comprises a first set of guide rod receiving holes in an edge of the tray support block, said guide rod support holes being dimensioned to receive the guide rods in a sufficiently tight fit to hold the sample tray in place such that the multiplicity of sites are in fixed x and y positions, but allowing a user to manually remove the sample tray from the support block, said guide rod support holes extending into said block, and
the guide rods are inserted into the guide rod receiving holes such that the sample tray sits with the first edge against the edge of the support block that contains the holes.

3. The tray assembly of claim 2 in which each guide rod comprises a groove positioned around its circumference and the tray support block comprises a threaded hole and a thumbscrew located in the hole such that the thumbscrew engages the groove when the tray is positioned with the guide rods in the first set of holes.

4. The tray assembly of claim 1 in which the support legs are in the form of plates and the first and second edges have holes through which the clamp and tray support blocks respectively are secured with screws.
